(19) United States
(12) Patent Application Publication
(10) Pub. No.: US 2021/0025834 A1
(43) Pub. Date: Jan. 28, 2021

(54) Image Capturing Devices and Associated Methods

(71) Applicant: Laser Products Industries, Inc., Romeoville, IL (US)

(72) Inventors: Erik Louis, Romeoville, IL (US); Brian Stoiber, Romeoville, IL (US); Daniel Louis, Romeoville, IL (US); Kevin Yeh, Romeoville, IL (US); Richard Katzmann, Romeoville, IL (US); Michael Walker, Rochester, NY (US); Larry Wells, Romeoville, IL (US); Scott Seyfried, Rochester, NY (US)

(21) Appl. No.: 16/931,550

(22) Filed: Jul. 17, 2020

Related U.S. Application Data
(60) Provisional application No. 62/877,343, filed on Jul. 23, 2019.

(51) Int. Cl. G01N 21/956; G01N 21/88; G06T 7/00

(52) U.S. Cl. CPC G01N 21/956; G06T 2207/30132; G06T 7/0004; G01N 21/8851

(57) ABSTRACT

Portable devices for capturing images of a surface of a building material and associated methods are disclosed. In some embodiments, the portable device includes (i) a housing, (ii) an image sensor positioned in the housing and configured to capture images of the surface at multiple time points when the housing is moved along a trajectory on the surface; (iii) a lighting component configured to illuminate the surface; (iv) an encoder configured to measure a distance travelled by the housing; and (v) a controller communicably coupled to the image sensor and the encoder. The controller instructs the image sensor to capture the images of the surface at least partially based on the measured distance travelled by the housing.

### CROSS-REFERENCE TO RELATED APPLICATION(S)

This application claims priority to U.S. Provisional Patent Application No. 62/877,343, filed on Jul. 23, 2019, the entire contents of which is incorporated herein by reference.

### TECHNICAL FIELD

The present technology is directed to an image capturing device for building/construction materials. More particularly, some embodiments of the present technology relate to a portable, hand-held device for capturing images of a surface of a slab and associated methods.

### BACKGROUND

Knowing characteristics of a building material is crucial in design stages. One way to measure or collect the characteristics is to capture an image of that building material. Capturing images of building materials can be challenging especially for the materials having relatively large sizes and weights, such as slabs. Some building materials have high reflectively which makes capturing images thereof even more challenging. One conventional method for capturing images of a slab is to bring the slab into a photography studio that has enough physical space to accommodate the slab. This method is, however, time consuming, expensive, and inefficient. Therefore, there is a need for an improved device or method to address the foregoing issues.

### BRIEF DESCRIPTION OF THE DRAWINGS

Many aspects of the present technology can be better understood with reference to the following drawings. The components in the drawings are not necessarily to scale. Instead, emphasis is placed on illustrating the principles of the present technology.

FIG. 1 is a schematic, isometric view of a portable image capturing device in accordance with an embodiment of the present technology.

FIG. 2 is a schematic, partial isometric view of the portable image capturing device in accordance with an embodiment of the present technology.

FIG. 3A is a bottom view of the portable image capturing device in accordance with an embodiment of the present technology.

FIG. 3B is a partial bottom view of another portable image capturing device in accordance with an embodiment of the present technology.

FIG. 3C is a bottom view of yet another portable image capturing device in accordance with an embodiment of the present technology.

FIG. 3D is an enlarged view of a light diffuser in accordance with an embodiment of the present technology.

FIG. 4 is a schematic, cross-sectional diagram of a portable image capturing device in accordance with an embodiment of the present technology.

FIG. 5 is a schematic diagram illustrating operation of a slab scanner in accordance with an embodiment of the present technology.

FIGS. 6A and 6B are schematic diagrams illustrating images captured by a slab scanner in accordance with an embodiment of the present technology.

FIGS. 7A and 7B illustrate a commercial application of a portable image capturing device in accordance with an embodiment of the present technology.

FIG. 8 is a flowchart illustrating a method in accordance with an embodiment of the present technology.

FIG. 9 is a flowchart illustrating a method in accordance with an embodiment of the present technology.

### DETAILED DESCRIPTION

In various embodiments, the present technology relates to a portable image capturing device (or scanner) for building materials, such as a slab, surface coating materials on a flat surface (e.g., wall, floor, ceiling, etc.), and/or other suitable materials. The present technology also relates to methods of operating the portable image capturing device. The portable image capturing device has a compact, portable design and can be held and operated by a single operator. The portable image capturing device is configured to capture multiple images of a surface of a building material, when the portable image capturing device is positioned on the surface and moved thereon. The captured images can be analyzed, adjusted, and/or stored for future use (e.g., for design projects considering using the slab as a building material).

In some embodiments, the portable image capturing device includes a housing, an image sensor (e.g., in a camera) positioned in the housing, and one or more lighting components (e.g., one or more LED (light-emitting diode) light strips or bulbs) positioned in the housing. The housing can have an interior surface with a low-reflective or anti-reflective coating (or film). The lighting components are spaced apart from the image sensor. The lighting components are positioned such that the light rays emitted by the lighting components do not directly reach the image sensor (e.g., the first reflected rays of the emitted light rays do not reach the image sensor). In some embodiments, the lighting components can each be positioned in a recess formed with the housing such that the light rays emitted from the lighting component are not directly reflected to the image sensor.

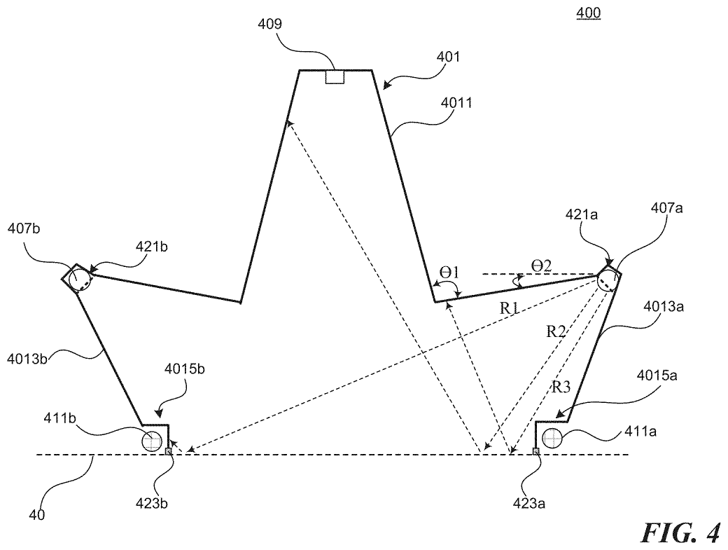

For example, the surface of an object to be scanned (e.g., a slab) can first reflect the light rays from the lighting component (the light rays' first reflections), not directly toward the image sensor (see e.g., FIG. 4). By this arrangement, the portable image capturing device can capture images of the surface (i) that have no “glare” thereon (e.g., a white spot or region on an image, usually caused by excessive lighting) and (ii) that have image quality and characteristics close to those of the images taken in a natural lighting environment (e.g., a room with one or more light sources, such as a ceiling light, a recessed light, a lamp, external sun light from a window, etc.). The captured images can be analyzed (e.g., to determine the types of the object to be scanned), adjusted (e.g., to determine an edge of the object, to calibrate colors and/or light consistency of the image, etc.), and stored for further use (e.g., for interior designs of a building, a structure, a room, etc.).

Another aspect of the present technology includes methods of analyzing, organizing, and utilizing the captured images. In some embodiments, the method can include (1) determining a boundary or an edge of the scanned object based on captured images; (2) identifying a type of the scanned object based on the captured images; (3) adjusting the color (and/or light consistency) or distortion of the captured images; (4) identifying a defect or a mark on the scanned object based on the captured images; and/or (5) consolidating (e.g., stitching, combining, incorporating, etc.) the captured images to form a processed image that is indicative of the characteristics of the scanned object.

In some embodiments, the method can include (i) determining (e.g., by an encoder or a processor) the dimensions of the scanned object based on the captured images; (ii) storing the captured and processed images based on the identified type and the determined dimensions; and/or (iii) transmitting or exporting, automatically or upon a user instruction, the stored images upon a request in various data formats (e.g., upon a request from an interior designer, exporting the stored images from a server to a client computing device with particular software installed).

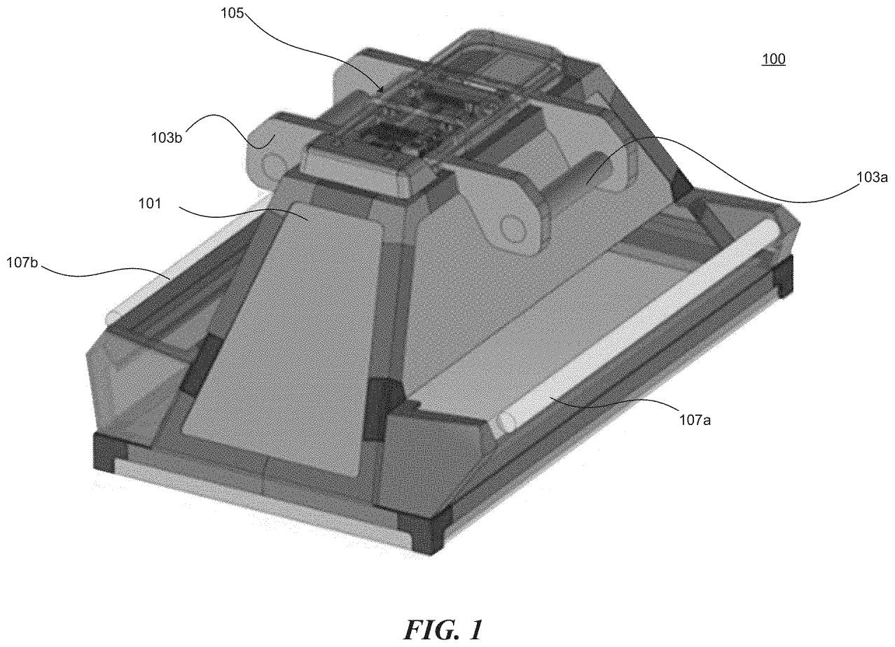

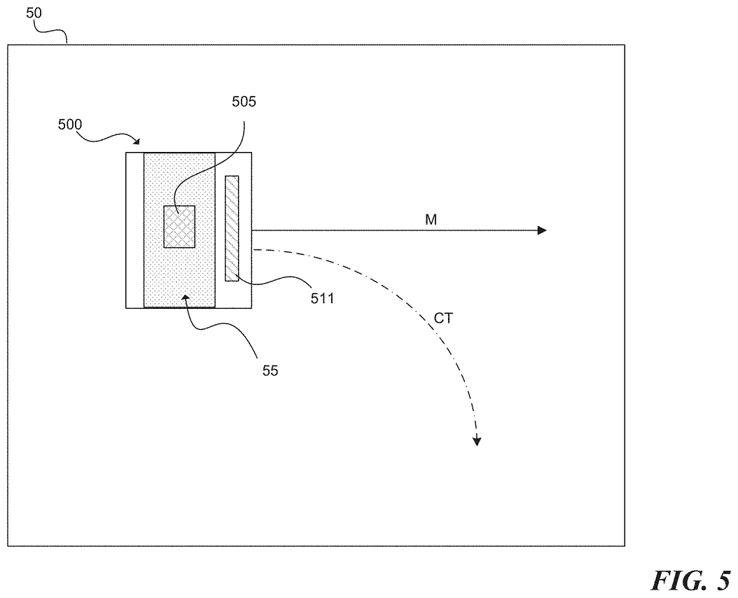

Specific details of several embodiments of image capturing devices and associated systems and methods are described below. FIG. 1 is a schematic, isometric view of a portable image capturing device 100 in accordance with an embodiment of the present technology. The portable image capturing device 100 has a compact, portable design and can be operated by one operator. As shown, the portable image capturing device 100 includes a housing 101 and two handles 103a, 103b coupled to the housing 101. The handles 103a, 103b are each positioned at one side of the housing 101 and are each configured to be held by one hand of an operator of the portable image capturing device 100. For example, the operator can hold the handles 103a, 103b and move the portable image capturing device 100 on/along a surface of an object to be scanned. Embodiments regarding the operation of the portable image capturing device 100 are discussed below in detail with reference to FIG. 5.

In some embodiments, the portable image capturing device 100 can have only one handle. In some embodiments, the portable image capturing device 100 can be moved by the operator holding other suitable components such as a knob, a lever, a protrusion, etc., formed with the housing 101. In some embodiments, the portable image capturing device 100 can include more than two handles. In some embodiments, the sizes and dimensions of the two or more handles can be different.

In the illustrated embodiment, the housing 101 has a generally symmetric shape. In other embodiments, the housing 101 can have other suitable shapes. In some embodiments, the housing 101 can have an interior surface with a low-reflective or anti-reflective coating or film.

As shown in FIG. 1, the portable image capturing device 100 includes a controller 105 covered by the housing 101. The controller 105 is configured to control the operation of the portable image capturing device 100. In some embodiments, the controller 105 can include one or more of: a processor, circuitry, control logics, a control chip, etc. In some embodiments, the controller 105 can include one or more printed circuit boards (PCB) mounted on the housing 101. In some embodiments, the controller 105 can be configured to (i) control an image capturing process (e.g., to instruct an image sensor to capture images); (ii) to coordinate the movement of the portable image capturing device 100 with the image capturing process (e.g., record the location of the portable image capturing device 100 when the images are captured); and/or (iii) to analyze or process images collected by the image capturing process.

In some embodiments, the controller 105 can be a computing system embedded in a chip, a PCB board, or the like. In some embodiments, the controller 105 can include a memory or suitable storage component that is configured to store collected images or software/firmware for processing the collected images. In some embodiments, the controller 105 can be communicably coupled to other components of the device 100 (e.g., image sensor 109, lighting components 107, roller 111, etc. as discussed below) and control these components. In some embodiments, the controller 105 can include a relatively small and affordable computer system such as Raspberry Pi.

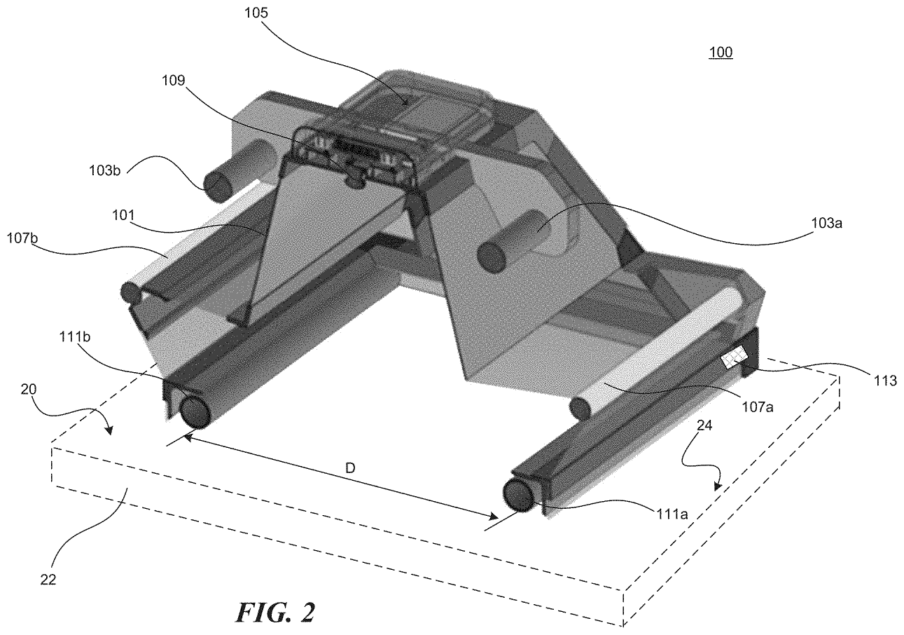

In the illustrated embodiments shown in FIG. 1, the portable image capturing device 100 includes a plurality of (e.g. two) lighting components 107a, 107b positioned inside the housing 101. In one embodiment, the lighting components 107a, 107b are positioned at opposing sides of the housing 101 and spaced apart from the center of the housing 101. The lighting components 107a, 107b are configured to illuminate a surface of an object to be scanned, so as to facilitate the image capturing process of the portable image capturing device 100. In some embodiments, the lighting components 107a, 107b are each positioned, at least partially, in a recess formed by an interior surface of the housing 101. By this arrangement, the light rays emitted from the lighting components 107a, 107b are not directly reflected to an image sensor positioned at the center of the housing 101 (see e.g., FIG. 2).

In some embodiments, the lighting components 107a, 107b can include one or more LED light strips or light bulbs. In some embodiments, the portable image capturing device 100 can have more than two lighting components. For example, the portable image capturing device 100 can have a plurality of lighting components circumferentially positioned inside the housing 101.

FIG. 2 is a schematic, partial isometric view of the portable image capturing device 100. As shown, the portable image capturing device 100 includes an image sensor 109 positioned in the housing 101 and configured to collect images of a surface 20 of an object 22. As shown in FIG. 2, the image sensor 109 is communicably coupled to the controller 105. For example, in some embodiments, the image sensor 109 can be coupled to the controller 105 by a wire, a cable, a connector, or the like. In some embodiments, however, the image sensor 109 can communicate with the controller 105 by a wireless communication, such as a Near Field Communication (NFC), Wi-Fi, or Bluetooth. The image sensor 109 is controlled by the controller 105 to collect images of the surface 20 during an image capturing process. In some embodiments, the image sensor 109 can be a camera module. In some embodiments, the image sensor 109 can include a charge-coupled-device (CCD) image sensor. In some embodiments, the image sensor 109 can include a complementary-metal-oxide-semiconductor (CMOS) image sensor.

As also shown in FIG. 2, the portable image capturing device 100 includes two rollers (or wheels) 111a, 111b, each positioned at one side of the housing 101. The rollers 111a, 111b are configured to move the portable image capturing device 100. For example, an operator of the portable image capturing device 100 can rotate the rollers 111a, 111b against the surface 20 to move the portable image capturing device 100 on/along the surface 20. When the portable image capturing device 100 travels on the surface 20, the image sensor 109 can collect images of different portions of the surface 20. The collected images can then be analyzed and combined into a processed image that shows the (e.g., visual) characteristics of the surface 20 of the object 22.

In some embodiments, the portable image capturing device 100 can include a distance sensor 113 coupled to the roller 111a. The distance sensor 113 is configured to measure and record the distance traveled by the portable image capturing device 100. In some embodiments, the distance sensor 113 can include an encoder that can convert distance information to a digital signal, which can later be transmitted to the controller 105. In some embodiments, the controller 105 can instruct the image sensor 109 to take an image according to the distance information measured by the distance sensor 113.

For example, at a first time point T₁, the controller 105 can instruct the image sensor 109 to take a first image of a first portion of the surface 20 that is covered by the housing 101 at the first time point T₁. Assume that the distance between the rollers 111a, 111b is distance D. When the distance sensor 113 measures that the portable image capturing device 100 has traveled distance D (or a distance less than distance D such that there can be an overlap between two captured images) at a second time point T₂, the controller 105 can instruct the image sensor 109 to take a second image of a second portion of the surface 20 that is covered by the housing 101 at the second time point T₂. In some embodiments, the controller 105 can instruct the image sensor 109 to take additional images at other time points. For example, the image sensor 109 can take an image at a third time point T₃ when the distance sensor 113 measures that the portable image capturing device 100 has traveled a half of distance D. In some embodiments, the foregoing image taking process can repeat until the image sensor 109 has taken enough images to form an overall image for the whole surface 20 of the object 22.

In some embodiments, the first and second images (as well as other images taken) can be combined and/or processed by the controller 105 so as to form a processed image. In some embodiments, the first and second images can be processed by a processor or a computer external to the portable image capturing device 100. In some embodiments, the controller 105 can program the encoder 113 to move a distance to ensure that the first and second captured images overlap and can then analyze the first and second images and determine how to combine the first and second images. For example, the controller 105 can combine the first and second images by removing a duplicate portion of the first or second image and then “stitch” the first and second images to form the processed image. In some embodiments, the controller 105 can identify an edge 24 of the surface 20 in the first and second images, and then remove a corresponding part (e.g., the part of image external to the image of the edge 24) of the first and second images.

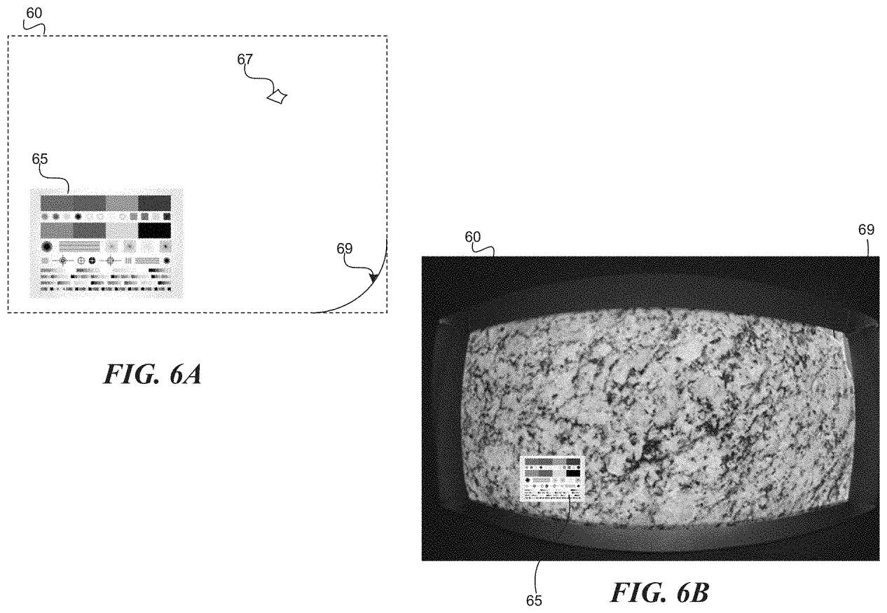

In some embodiments, the controller 105 can adjust the colors (and/or light consistency) of the first and second images (and other captured images) based on a color reference (e.g., a physical color bar, a reference object that has been scanned together with the object 22, etc.). The color reference is indicative regarding how a surface of a building material looks like in a specific lighting environment (e.g., natural lighting during a day, a room with ceiling lights, a room with lamps, etc.). In some embodiments, the controller 105 can first compare (i) a portion of a collected image that shows the color reference with (ii) the remaining portion of the collected image. The controller 105 can then adjust the remaining portion of the collected image based on the color reference to form an adjusted image. The adjusted image can visually present the surface 20 in the specific lighting environment. It is advantageous to have such an adjusted image in a design stage when considering whether and how to use the object 22 as a building material for a project. Embodiments regarding adjusting colors are discussed below in detail with reference to FIGS. 6A and 6B.

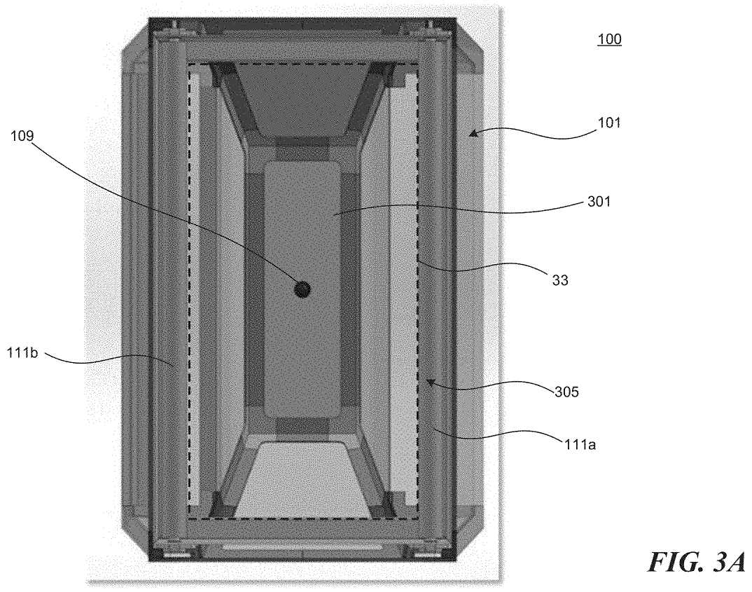

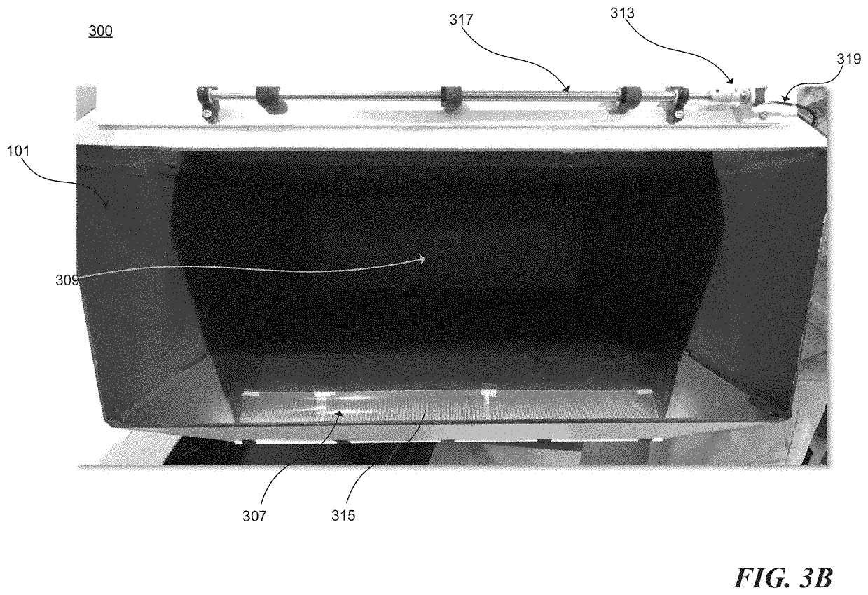

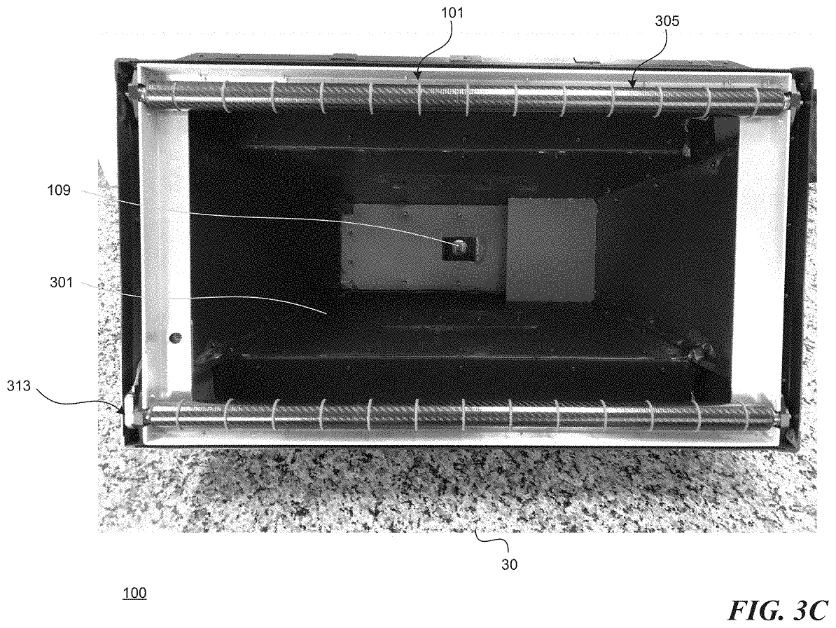

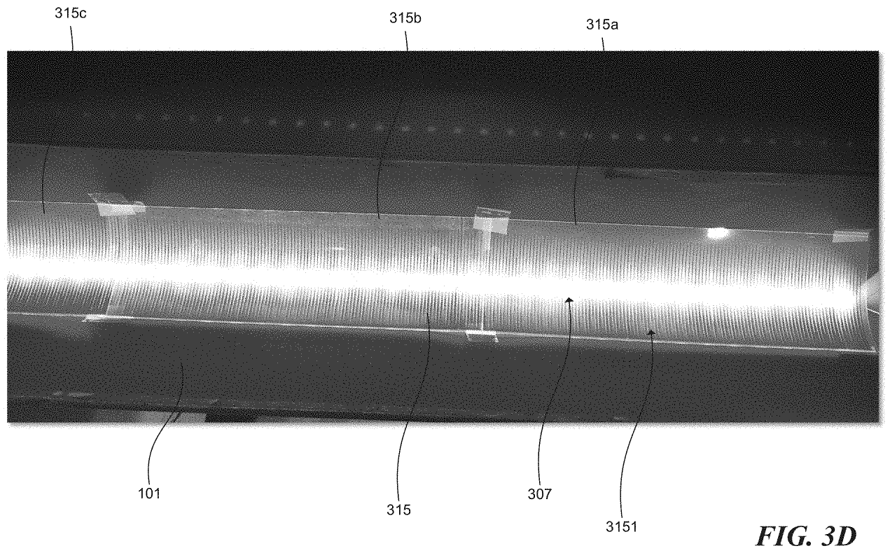

FIG. 3A is a bottom view of the portable image capturing device 100 in accordance with an embodiment of the present technology. As shown in FIG. 3A, the image sensor 109 is positioned at the centroid or geometric center of a top, interior surface 301 of the housing 101. In some embodiments, the image sensor 109 can be positioned at other suitable locations, depending on the shape of the housing 101. For example, in embodiments where the housing 101 has an asymmetric shape, the image sensor 109 can be positioned at a location other than the center of the interior surface 301 of the housing 101.

FIG. 3A also shows an image capturing area 33 defined by a lower opening 305 of the housing 101. When an object (or a portion of the object) is positioned in the image capturing area 33, the image sensor 109 can capture the image of that object (or the portion of that object). Note that the two lighting components 107a, 107b (FIG. 1 or 2) are not visible in FIG. 3A. By this arrangement, the light rays emitted from the lighting components 107a, 107b are not directly reflected to the image sensor 109.

FIG. 3B is a partial bottom view of another portable image capturing device 300 in accordance with an embodiment of the present technology. The portable image capturing device 300 includes a housing 101, an image sensor 309 positioned at the center of the housing 101, and a lighting component 307 covered by a light diffuser 315. FIG. 3B is a “tilted” bottom view and therefore the lighting component 307 covered by the light diffuser 315 can be visible in FIG. 3B. In some embodiments, the light diffuser 315 can include patterns therein or thereon such that the light diffuser 315 can adjust or change the directions of light rays passing through the light diffuser 315. In some embodiments, for example, the light diffuser 315 can adjust light rays from one or more light sources into a set of light rays substantially parallel to one another. In some embodiments, the light diffuser 315 can be adjusted to mask some of the light to create even illumination across the surface by partially or entirely blocking bright spots. In some embodiments, light diffuser 315 can be a transparent or translucent film with suitable components (e.g., beads) embedded therein. In some embodiments, the light diffuser 315 can be made of plastic or other suitable materials. In some embodiments, the portable image capturing device 300 can operate without the light diffuser 315.

As shown in FIG. 3B, the portable image capturing device 300 can include a supporting structure 317 configured to support a roller or wheel. The supporting structure 317 is coupled to an encoder 313, which measures the distance traveled by the portable image capturing device 300 and then generates/encodes/transmits a signal to a controller of the portable image capturing device 300, via a connector 319. Based on the signal, the controller of the portable image capturing device 300 can instruct the image sensor 309 to capture an image covered by the housing 101.

FIG. 3C is a bottom view of yet another portable image capturing device 100 in accordance with an embodiment of the present technology. Some components and/or features shown in FIG. 3C are similar to those illustrated in FIG. 3A and are not separately described in this section. As shown in FIG. 3C, the image sensor 109 is positioned at the centroid or geometric center of a top, interior surface 301 of the housing 101. In some embodiments, the encoder 313, which measures/records the distance traveled by the portable image capturing device 100, is positioned adjacent to one of the wheels 305.

In some embodiments, the distance measured by the encoder 313 can be used by the controller (not shown in FIG. 3C) to plot a trajectory for the device to ensure that the entire surface 30 may be imaged. For example, the device can travel linearly (or in a curved trajectory) across the surface 30 for a distance at which time the light source and camera can strobe to capture an image. In other embodiments, the distances measured by the encoder 313 can be used to verify the dimensions and/or shape of the surface being imaged.

FIG. 3D is an enlarged view of the light diffuser 315 in accordance with an embodiment of the present technology. As shown, the light diffuser 315 can include first, second, and third portions 315a, 315b, and 315c coupled to one another. In other embodiments, the light diffuser 315 can have a different number of portions. As shown, the light diffuser 315 includes a pattern 3151. In the illustrated embodiments, the pattern 3151 includes a linear/stripe pattern. In some embodiments, the pattern 3151 can include other suitable patterns such as circles, waves, bubbles, pyramids, etc. In the illustrated embodiments, the first, second, and third portions 315a, 315b, and 315c have the same pattern 3151. In other embodiments, however, the first, second, and third portions 315a, 315b, and 315c can have different patterns.

In some embodiments, the functionality of the light diffuser 315 may be implemented through light mapping in software. In an example, instead of using the light diffuser 315 to provide an even light field, the brightness of each pixel that is captured by the image sensor is adjusted based on its deviation from a known value. In another example, the adjustment may be based on a baseline value for “true white” that is recorded by placing the device on a white surface and capturing an image thereof. The brightness of each captured pixel may be compared to the baseline value and adjusted, thereby approximating the functionality of the diffuser pattern discussed above.

FIG. 4 is a schematic, cross-sectional diagram of a portable image capturing device 400 in accordance with an embodiment of the present technology. The portable image capturing device 400 is configured to collect images of a surface 40 of a material. The portable image capturing device 400 includes (i) a housing 401, (ii) a camera 409 positioned inside the housing 401, (iii) two LED light strips or tubes 407a, 407b respectively positioned in recesses 421a, 421b formed with the housing 401, and (iv) two wheels or rollers 411a, 411b configured to move the portable image capturing device 400.

As shown, the housing 403 includes a center portion 4011, two side portions 4013a, 4013b, and two bottom portions 4015a, 4015b. The center portion 4011 is coupled to the side portions 4013a, 4013b. The side portions 4013a, 4013b are coupled to the bottom portions 4015a, 4015b. In some embodiments, the center portion 4011, the side portions 4013a, 4013b, and the bottom portions 4015a, 4015b can be coupled by welding, connectors, nuts/bolts, etc. In some embodiments, the center portion 4011, the side portions 4013a, 4013b, and the bottom portions 4015a, 4015b can be integrally formed (e.g., by molding).

The center portion 4011 is positioned and spaced apart (or elevated) from the surface 40 of the material during operation. By this arrangement, the light rays emitted by the LED light tubes 407a, 407b (which are at least partially positioned in the recesses 421a, 421b formed with the side portions 4013a, 4013b) do not directly reach the image sensor 409 positioned at the center of the center portion 4011.

In FIG. 4, first, second, and third light rays R₁, R₂, and R₃ are shown as examples. The first light ray R₁ first reaches the surface 40, and then its first reflected ray reaches the bottom portions 4015b. The second light ray R₂ first reaches the surface 40, and then its first reflected ray reaches the center portions 4011. The third light ray R₃ first reaches the surface 40, and then its first reflected ray reaches the side portion 4013a. None of the first reflected light rays of the light rays R₁, R₂, and R₃ directly reach the camera 409. By this arrangement, the images of the surface 40 captured by the camera 409 would not have clear or obvious white spots or regions (caused by excessive or direct lighting) thereon.

As shown in FIG. 4, the center portion 4011 and the side portion 4013a together form or define a first angle θ1. The side portion 4013a and the surface 40 together form or define a second angle θ2. In some embodiments, the first angle θ1 can range from 90 to 140 degrees (e.g., a first range). In some embodiments, the second angle θ2 can range from 10 to 45 degrees (e.g., a second range).

In some embodiments, the position of the corner corresponding to the first angle relative to the position of the camera (or image sensor) 409 and the light source 407a is selected to ensure that a direct reflection from the light source does not reach the camera (e.g., light rays R₁, R₂ and R₃ reflect at least twice before reaching the image sensor).

In some embodiments, the light sources 407a, 407b are laterally spaced apart from the image sensor 409 advantageously using dark field illumination to illuminate the surface 40. That is, specular reflection (e.g., reflection of light waves from a surface) is directed away from the image sensor, and only diffused reflected light is measured and imaged. This results in an image wherein the surface 40 is brightly lit with a dark background since the color or brightness distortion caused by the direct reflection of light is eliminated.

The two wheels 411a, 411b are positioned outside the bottom portions 4015a, 4015b and are configured to move the portable image capturing device 400 along the surface 40. When the portable image capturing device 400 is in operation, the lower section of the bottom portions 4015a, 4015b are in close contact with the surface 40, such that no external light rays get into the housing 403. In some embodiments, to achieve this goal, the portable image capturing device 400 can include a contacting components 423a, 423b (e.g., a rubber seal, a light blocker, etc.) positioned between the surface 40 and the bottom portions 4015a, 4015b, respectively.

FIG. 5 is a schematic diagram (a top view) illustrating operation of a surface scanner 500 in accordance with an embodiment of the present technology. The surface scanner 500 includes a controller 503 and is driven by wheels 511 controlled by the controller 503. An operator can hold the surface scanner 500 and position it on a slab 50. When the surface scanner 500 is moved by the operator in direction M, the surface scanner 500 can capture an image in an image capturing area 55. The wheels 511 can track the distance travelled by the surface scanner 500 and then instruct the controller 505 to capture images in the image capturing area 55 at multiple, different time points.

In some embodiments, the surface scanner 500 can be moved in a curvature trajectory CT. In such embodiments, the wheel 511 can include multiple rolling components such that when they rotate at different rates, the surface scanner 500 can be moved in the curvature trajectory CT. In the similar fashion as described above, the wheels 511 can provide information regarding how the surface scanner 500 has been moved, and then the controller 505 can accordingly instruct the surface scanner 500 to capture images in the image capturing area 55. The images captured at the multiple time points can then be combined to form an overall image of the slab 50. In some embodiments, the surface scanner 500 can operate without the wheels 511.

FIGS. 6A and 6B are diagrams illustrating images captured by a slab scanner in accordance with an embodiment of the present technology. As shown, an image 60 captured by the slab scanner can include a color reference area 65. The color reference area 65 is generated by capturing the image of a color reference bar when the slab scanner scans a slab. In some embodiments, the color reference bar is physically attached to the slab. In some embodiments, the color reference bar can be positioned inside a housing of the slab scanner such that, when the slab is scanned, the color reference bar can be scanned at the same time. In some embodiments, the color reference area 65 can include a color bar, a color chart, and/or other suitable color reference.

In some embodiments, the color reference bar can be held by a holding component (e.g., a holding arm, a clamp, etc.) inside a housing of the slab scanner. The holding component can move, rotate, and/or fold the color reference bar such that the color reference bar can be switched between a first position (where the color reference bar will be scanned) and a second position (where the color reference bar will not be scanned). Accordingly, the operator of the slab scanner can determine whether to put the color reference bar in the image 60. In some embodiments, a controller of the slab scanner can operate the holding component based on a predetermined rule (e.g., only scan the color reference bar at first five images captured by the slab scanner). In some embodiments, the colors of the image 60 can be adjusted based on the image of the color reference bar (the color reference area 65).

In some embodiments, the image 60 can include a mark 67. The mark 67 can be the image of a defect of the slab. In some embodiments, the mark 67 can be the image of a sign created by an operator (e.g., a circle drawn by a marker, etc.) before scanning the surface of the slab. When processing the image 60 with the mark 67, the operator can be notified that a further action (e.g., fix the defect, polish the slab, etc.) may be required.

In some embodiments, the image 60 can include an edge 69. The edge is indicative of a boundary of the slab that has been scanned. When processing the image 60 with the edge 69, the image external to the edge 69 can be removed and a note suggesting a further action (e.g., check the boundary of the slab) can be sent to the operator.

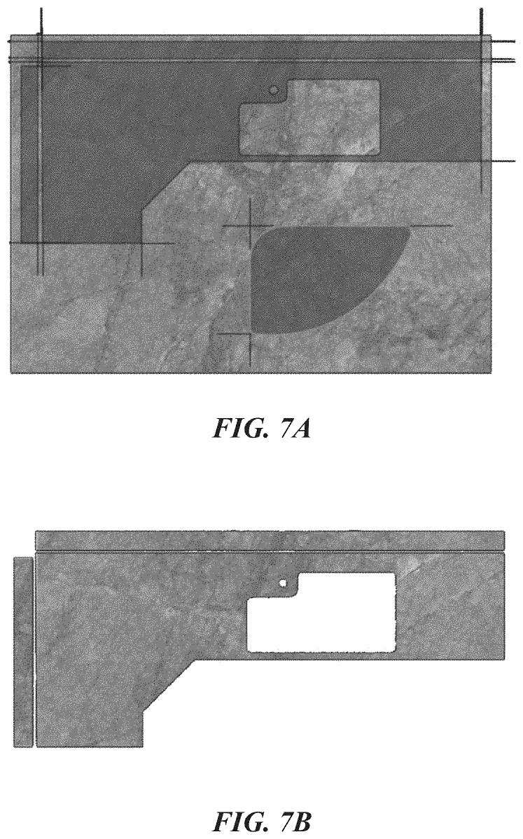

FIGS. 7A and 7B illustrate a commercial application of a portable image capturing device. Embodiments of the present technology advantageously enable the uniqueness of the surface of each marble or granite slab (both across slabs and within a slab itself) to be considered in the design of a countertop as shown in FIGS. 7A and 7B. In some embodiments, the present technology can be used to measure the surfaces of other types of building materials. FIG. 7A shows an image of a slab captured by an exemplary portable image capturing device that has been superimposed with a proposed design of a countertop, and FIG. 7B depicts how that specific countertop would look if created from the selected slab. The images captured by the disclosed technology enable a final and realistic look of a countertop design to be envisioned prior to its manufacture. In some embodiments, the captured images can be used to create a dimensionally accurate file (e.g., a computer-aided design, CAD, file) used for design and/or manufacturing.

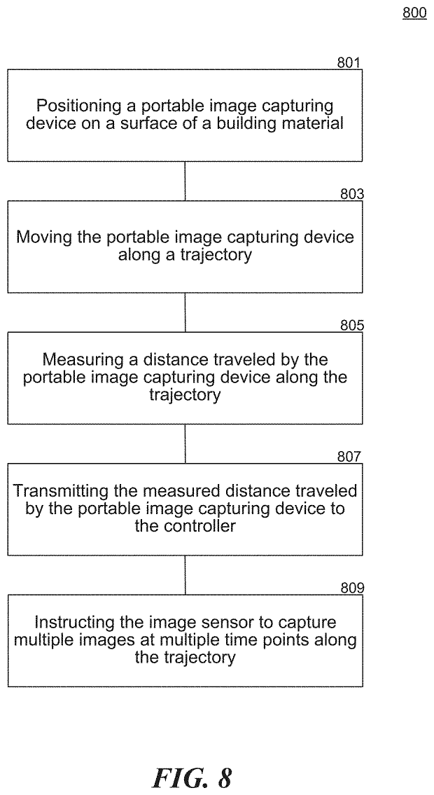

FIG. 8 is a flowchart illustrating a method 800 of operating a portable image capturing device or a slab scanner. The method 800 includes, at block 801, positioning the portable image capturing device on a surface of a building material. The portable image capturing device includes (1) a housing, (2) a lighting component configured to emit light rays to illuminate the surface, (3) an image sensor positioned in the housing and configured to collect images of the surface; (4) an encoder configured to measure the distance traveled by the portable image capturing device; and (5) a controller configured to instruct the image sensor (e.g., when and whether) to collect the images of the surface based on the distance measured by the encoder.

At block 803, the method 800 includes moving the portable image capturing device along a trajectory. In some embodiments, the trajectory can include straight lines, curves, or a combination thereof. In some embodiments, the trajectory passes over at least a substantial part (e.g., over 95%) of the surface of the building material. In some embodiments, the trajectory can pass over a small part of the surface of the building material.

At block 805, the method 800 includes measuring, by the encoder, a distance traveled by the portable image capturing device along the trajectory. At block 807, the method 800 continues by transmitting the measured distance traveled by the portable image capturing device to the controller. At block 809, the method 800 continues by instructing, by the controller based on the determined distance, the image sensor to capture multiple images at multiple time points along the trajectory. In some embodiments, the method 800 can include storing the captured images in a storage device (e.g., a hard drive, a flash drive, etc.) or a memory of the portable image capturing device. In some embodiments, the captured images can be transmitted to a server or an external computer via a wired or wireless connection (e.g., based on communication protocols, such as, Wi-Fi, Bluetooth, NFC, etc.).

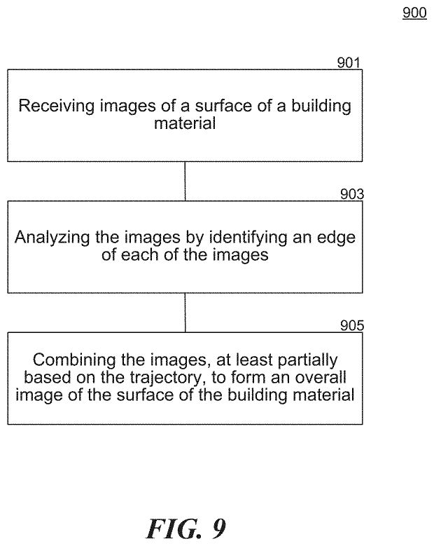

FIG. 9 is a flowchart illustrating a method 900 of processing images captured by a portable image capturing device or a slab scanner. The method 900 includes, at block 901, receiving, from a controller of a portable image capturing device, images of a surface of a building material. The images are captured by an image sensor of the portable image capturing device at multiple time points, along a trajectory passing over at least a substantial part of the surface of the building material. In some embodiments, the trajectory can pass over a small part of the surface of the building material.

At block 903, the method 900 includes analyzing the (captured) images by identifying an edge of each of the (captured) images. In some embodiments, the method 900 includes adjusting colors (and/or light consistency) of the captured images at least partially based on a color reference. In some embodiments, the method 900 includes identifying a mark in the captured images and adjusting the captured images accordingly. At block 905, the method 900 includes combining the (captured) images based on the trajectory so as to form an overall image of the surface of the building material. The overall image of the surface can be stored for further use (e.g., for design projects considering using the building material). In some embodiments, the captured images can be combined or stitched based on control points in the images without using the trajectory.

This disclosure is not intended to be exhaustive or to limit the present technology to the precise forms disclosed herein. Although specific embodiments are disclosed herein for illustrative purposes, various equivalent modifications are possible without deviating from the present technology, as those of ordinary skill in the relevant art will recognize. In some cases, well-known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein.

Throughout this disclosure, the singular terms “a,” “an,” and “the” include plural referents unless the context clearly indicates otherwise. Similarly, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Additionally, the term “comprising” is used throughout to mean including at least the recited feature(s) such that any greater number of the same feature and/or additional types of other features are not precluded. Reference herein to “one embodiment,” “some embodiment,” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

From the foregoing, it will be appreciated that specific embodiments of the present technology have been described herein for purposes of illustration, but that various modifications may be made without deviating from the scope of the invention. The present technology is not limited except as by the appended claims.

I/We claim:

1. A device for capturing an image of a surface of an object, comprising:
a housing having a center portion, a side portion coupled to the center portion, and a bottom portion coupled to the side portion;
an image sensor positioned at the center portion of the housing and configured to capture images of the surface at multiple time points when the housing is moved along a trajectory on the surface;
a lighting component positioned adjacent to the side portion of the housing and configured to illuminate the surface; and
a controller communicably coupled to the image sensor, the controller being configured to instruct the image sensor to capture the images of the surface at least partially based on a distance travelled by the housing.

2. The device of claim 1, wherein the center portion of the housing is elevated from an image capturing area defined by a lower opening formed with the bottom portion of the housing.

3. The device of claim 1, wherein the center portion, the side portion, and the bottom portion of the housing are integrally formed.

4. The device of claim 1, wherein the side portion of the housing is formed with a recess, and wherein the lighting component is at least partially positioned in the recess.

5. The device of claim 1, further comprising a contacting component coupled to the bottom portion of the housing.

6. The device of claim 1, wherein the center portion and the side portion together define a first angle, and wherein the side portion and the surface together define a second angle different than the first angle.

7. The device of claim 6, wherein the first angle has a first range from 90 to 140 degrees.

8. The device of claim 6, wherein the second angle has a second range from 10 to 45 degrees.

9. The device of claim 1, further comprising an encoder configured to measure the distance travelled by the housing to a signal.

10. The device of claim 9, wherein the encoder is configured to transmit the signal to the controller via a connector.

11. The device of claim 1, further comprising:
a roller positioned adjacent to the bottom portion of the housing and configured to facilitate the encoder to measure the distance travelled by the housing; and
a supporting structure configured to support the roller.

12. The device of claim 1, wherein the bottom portion of the housing is formed with a lower opening, and wherein the lowing opening defines an image capturing area.

13. The device of claim 12, wherein the image sensor is configured to capture the images of the surface in the image capturing area.

14. The device of claim 13, wherein the housing further comprises a color reference or a lighting reference, and wherein the device is configured to adjust the captured images based on the color reference or lighting reference.

15. A method of operating a portable image capturing device, the method comprising:
positioning the portable image capturing device on a surface of a building material, the portable image capturing device including a housing, a lighting component configured to emit light rays to illuminate the surface, an image sensor positioned in the housing, a roller configured to move the portable image capturing device, and a controller communicably coupled to the image sensor and the roller;
moving the portable image capturing device along a trajectory;
measuring, by the roller, a distance traveled by the portable image capturing device along the trajectory;
transmitting the measured distance traveled by the portable image capturing device to the controller; and
instructing, by the controller based on the determined distance, the image sensor to capture multiple images at multiple time points along the trajectory.

16. The method of claim 15, further comprising storing the captured images in a storage device or a memory of the portable image capturing device.

17. The method of claim 15, further comprising transmitting the captured images to a server via a wireless communication.

18. A method of processing images captured by a portable image capturing device, the method comprising:
receiving, from a controller of the portable image capturing device, images of a surface of a building material, wherein the images are captured by an image sensor of the portable image capturing device at multiple time points, along a trajectory passing over at least a portion of the surface of the building material;
analyzing the captured images by identifying an edge of each of the captured images; and
combining the captured images, at least partially based on the trajectory, to form an overall image of the surface of the building material.

19. The method of claim 18, further comprising adjusting colors of the captured images at least partially based on a color reference.

20. The method of claim 18, further comprising:
identifying a mark in the captured images; and
adjusting the captured images at least partially based on the mark.
